(19) United States
(12) Patent Application Publication
(10) Pub. No.: US 2005/0221684 A1
(43) Pub. Date: Oct. 6, 2005

(54) Electrical switching device

(76) Inventor: Kuo-Chu Yeh, Taipei (TW)

Correspondence Address: SUPREME PATENT SERVICES, POST OFFICE BOX 2339, SARATOGA, CA, 95070, US

(21) Appl. No.: 10/815,238

(22) Filed: Mar. 30, 2004

(51) Int. Cl. H01H 9/00

(52) U.S. Cl. 439/709

(57) ABSTRACT

An electrical switching device includes a base with input wires and output wires electrically connected to the base and opposite to the input wires, multiple conducting tubes electrically connected to and orthogonally mounted on the base, and multiple conducting plates each having holes to selectively allow an extension of some of the conducting tubes and screw holes selectively defined to correspond to and allow a bottom face of each of the screw holes to abut free ends of the rest of the conducting tubes such that screws are able to threadingly extend from the screw holes and into the free ends of the conducting tubes abutted to the bottom faces of the screw holes to secure engagement between conducting plate and the conducting tubes.

### BACKGROUND OF THE INVENTION

1. Field of the Invention

The present invention relates to an electrical switching device, and more particularly to the electrical switching device to allow the user to switch the electrical flow without dismantling the electronic device.

2. Description of Related Art

A conventional electronic device has a terminal block to control the direction of electrical flow or signal so as to change the operating manner of the electronic device. With the fast speed of electronics development, electronic devices become more and more complex and compact. Thus, available space is less and less than ever. As a consequence of available space becoming less in the modern electronic devices, the built-in wiring inside the electronic devices are extremely complex and complicated. Therefore, when doing maintenance or repairing of the electronic devices, a user, without proper knowledge how the built-in wiring is constructed, often damages the electronic devices and sometimes hurt himself or herself.

Therefore, how should the users properly do the maintenance or repairing of electronic devices without damaging the electronic devices becomes the primary objective of the present invention.

To overcome the shortcomings, the present invention intends to provide an electrical switching device to mitigate the aforementioned problems.

### SUMMARY OF THE INVENTION

The primary objective of the invention is to provide an electrical switching device to allow the user to change the electrical flow without dismantling the electronic device.

Another objective of the invention that the electrical switching device has multiple conducting tubes each with a height different from the others and multiple conducting plates each with multiple holes corresponding to some of the conducting tubes that pass through the conducting plates and screw holes corresponding to the rest of the conducting tubes that electrically connected to the conducting plates such that the conducting tubes are categorized into different groups each electrically connected to a corresponding one of the conducting plates to allow the user to easily change the electrical flow.

Other objects, advantages, and novel features of the invention will become more apparent from the following detailed description when taken in conjunction with the accompanying drawings.

### BRIEF DESCRIPTION OF THE DRAWINGS

FIG. 1 is an exploded perspective view of an electrical switching device of the present invention;

FIG. 1A is an enlarged perspective view showing that the conducting tube has an insulating layer coated outside the conducting tube;

FIG. 2 is a schematic perspective view showing that a first group of conducting plate is electrically connected to the first conducting tube;

FIG. 3 is a schematic perspective view showing that a second group of conducting tubes is electrically connected to the second conducting plate;

FIG. 4 is a schematic perspective view showing that a third group of conducting tubes is electrically connected to the third conducting plate; and

FIG. 5 is a schematic perspective view showing that a fourth group of conducting tubes is electrically connected to the fourth conducting plate to complete the assembly of the present invention.

### DETAILED DESCRIPTION OF PREFERRED EMBODIMENT

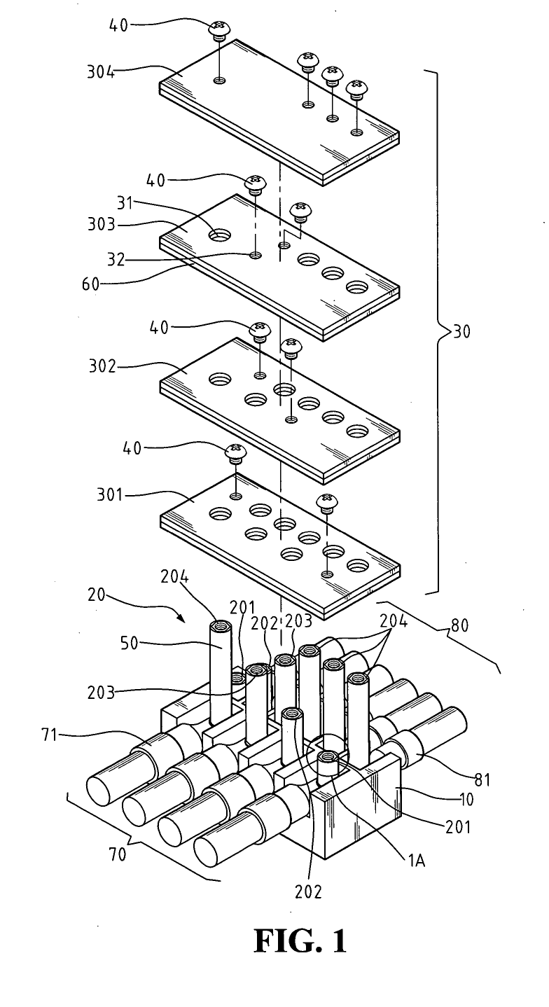

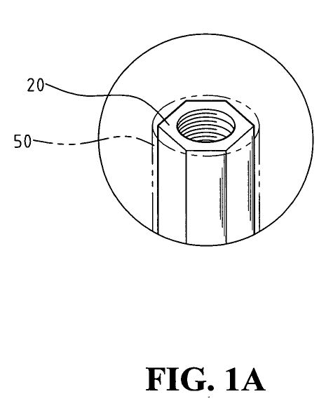

With reference to FIG. 1, it is to be noted that an electrical switching device 1 constructed in accordance with the present invention includes a base 10 made of metal, multiple conducting tubes 20 orthogonally mounted on a top face of the base 10, multiple conducting plates 30, screws 40, input wires 70 and output wires 80.

With reference to FIGS. 1 and 1A, the conducting tubes 20 are orthogonal to the top face of the base 10 and each has an insulating layer 50 mounted outside the conducting tube 20. The conducting tubes 20 are classified into a first group, a second group, a third group and a fourth group each having a unique height different from the other groups.

The conducting plates 30 are also categorize into a first conducting plate 301, a second conducting plate 302, a third conducting plate 303, and a fourth conducting plate 304. Each of the conducting plates 301, 302, 303, 304 has holes 31 corresponding to the second, the third and the fourth, the first, the third and the fourth, the first, the second and the fourth and the first, the second and the third groups of the conducting tubes 20 and screw holes 32 corresponding the first, the second, the third and the fourth groups of the conducting tubes 20. The input wires 70 are electrically connected to the first, second, third, and fourth groups of conducting tubes 20 and the output wires 80 are electrically connected to the first, second, third, and fourth groups of conducting tubes 20.

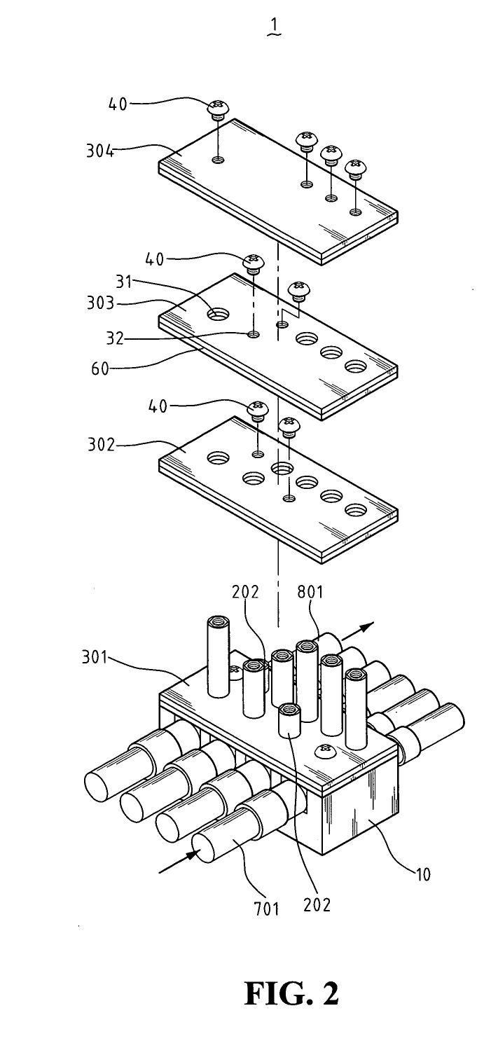

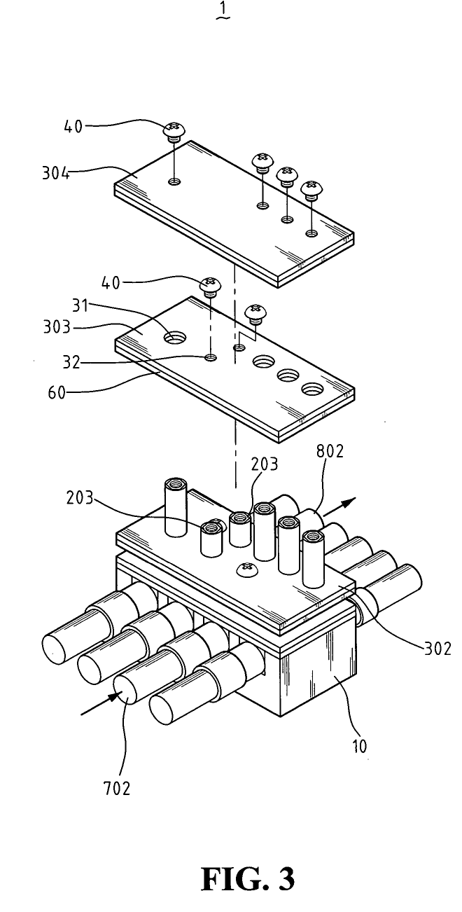

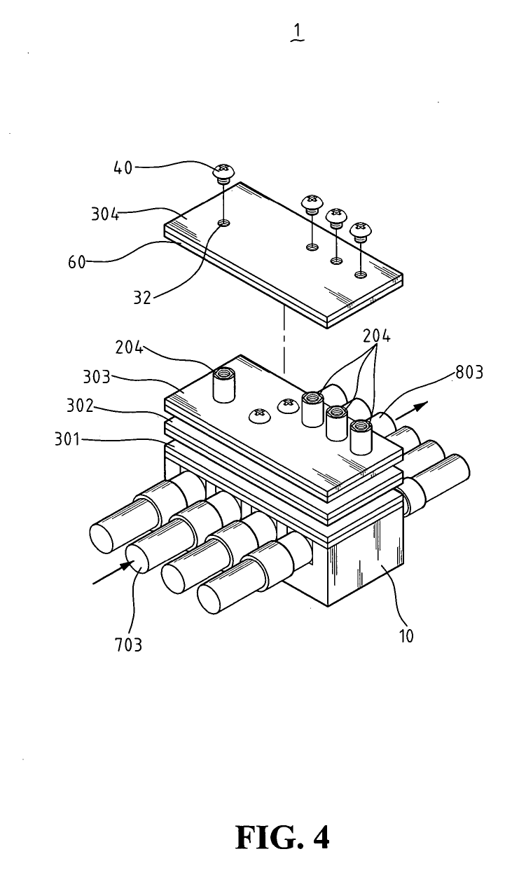

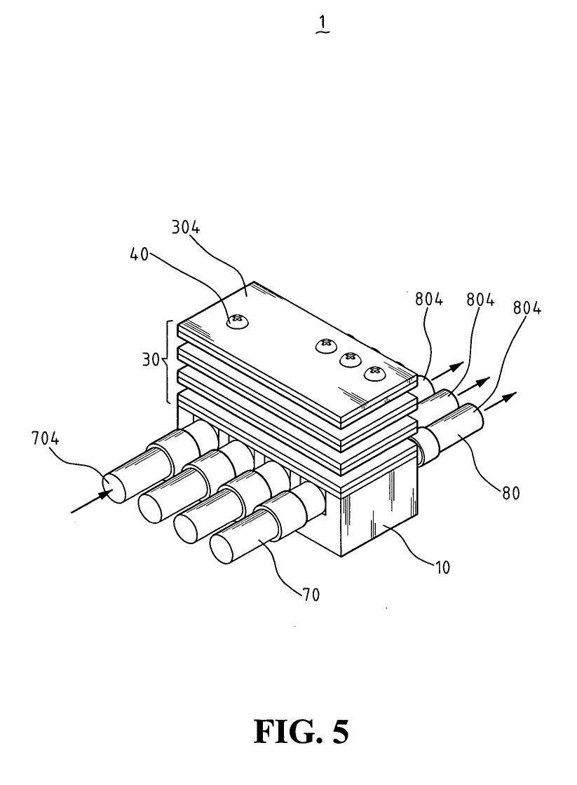

With reference to FIGS. 1-5, when the electrical switching device is to be assembled, the second, third and fourth groups of conducting tubes 20 extend through the holes 31 of the first conducting plate 301 and the first group of conducting tubes 20 abuts bottom faces of the screw holes 32. Screws 40 are threadingly extended into the threaded free ends of the first group of conducting tubes 20 to secure the engagement between the first conducting plate 301 and the first group of conducting tubes 20. In order to prevent unwanted electrical connection between the conducting tubes 20 and the conducting plates 30, an insulating plate 60 is securely attached to a bottom face of each of the first conducting plates 301.

Then the first, third and fourth groups of conducting tubes 20 extend through the holes 31 of the second conducting plate 302 and the second group of conducting tubes 20 abuts bottom faces of the screw holes 32. Screws 40 are threadingly extended into the threaded free ends of the first group of conducting tubes 20 to secure the engagement between the second conducting plate 302 and the second group of conducting tubes 20. In order to prevent unwanted electrical connection between the conducting tubes 20 and the conducting plates 30, an insulating plate 60 is securely attached to a bottom face of each of the second conducting plates 302.

The first, second and fourth groups of conducting tubes 20 extend through the holes 31 of the third conducting plate 303 and the third group of conducting tubes 20 abuts bottom faces of the screw holes 32. Screws 40 are threadingly extended into the threaded free ends of the third group of conducting tubes 20 to secure the engagement between the third conducting plate 302 and the third group of conducting tubes 20. In order to prevent unwanted electrical connection between the conducting tubes 20 and the conducting plates 30, an insulating plate 60 is securely attached to a bottom face of each of the third conducting plates 30.

Thereafter, the fourth group of conducting tubes 20 abuts bottom faces of the screw holes 32. Screws 40 are threadingly extended into the threaded free ends of the fourth group of conducting tubes 20 to secure the engagement between the fourth conducting plate 304 and the fourth group of conducting tubes 20. In order to prevent unwanted electrical connection between the conducting tubes 20 and the conducting plates 30, an insulating plate 60 is securely attached to a bottom face of each of the fourth conducting plates 30.

After the aforementioned assembly, it is noted that the user is able to have different electrical connection between the input wires 70 and the output wires. For example, when the first group of conducting tubes 20 is employed, electricity is provided to the first input wire 701 and the electricity is transmitted to the first output wire 801. When the second group of conducting tubes 20 is employed, electricity is provided to the first input wire 702 and the electricity is transmitted to the first output wire 802. When the third group of conducting tubes 20 is employed, electricity is provided to the first input wire 703 and the electricity is transmitted to the first output wire 803. When the third group of conducting tubes 20 is employed, electricity is provided to the first input wire 704 and the electricity is transmitted to the first output wire 804. Therefore, the user is able to choose different groups to divert the electricity direction without using a jumper or a jump wire to change direction of the electricity flow.

It is to be noted that the last conducting plate (304 in this preferred embodiment) has only screw holes 32 to allow the extension of the screws 40 to secure the engagement between the fourth conducting plate 304 and the fourth group of conducting tubes 204.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. An electrical switching device comprising:
a base with input wires and output wires electrically connected to the base and opposite to the input wires;
multiple conducting tubes electrically connected to and orthogonally mounted on the base, the conducting tubes being classified into a first group of conducting tubes and a last group of conducting tubes, the first group of conducting tubes having a height different from that of the last group of conducting tubes;
a first conducting plate having holes defined to allow an extension of the last group and screw holes defined to correspond to and allow a bottom face of each of the screw holes to abut free ends of the first group of conducting tubes such that screws are able to threadingly extend from the screw holes and into the free ends of the first group of conducting tubes to secure engagement between the first conducting plate and the first group of conducting tubes; and
a last conducting plate having last screw holes defined to correspond to and allow a bottom face of each of the last screw holes to abut free ends of the last group of conducting tubes such that last screws are able to threadingly extend from the last screw holes and into the free ends of the last group of conducting tubes to secure engagement between the last conducting plate and the last group of conducting tubes,
whereby electricity direction is changeable by selecting a specific input wire and sequentially a specific output wire is determined.

2. The electrical switching device as claimed in claim 1, wherein an insulating layer is coated to an outside of each of the conducting tubes.

3. The electrical switching device as claimed in claim 1, wherein an insulating plate is added to the bottom face of each of the first and second conducting plates.

4. The electrical switching device as claimed in claim 2, wherein an insulating plate is added to the bottom face of each of the first and second conducting plates.

5. The electrical switching device as claimed in claim 1 further comprising a third group of conducting tubes electrically connected to and orthogonally mounted on the base and a third conducting plate sandwiched between the first and the last conducting plates and having third holes defined to allow an extension of the last group of conducting tubes and third screw holes defined to correspond to and abut free ends of the third group of conducting tubes such that third screws are able to threadingly extend from the third screw holes and into the free ends of the third group of conducting tubes to secure engagement between the third group of conducting tubes and the third conducting plate, wherein the third group of conducting tubes has a height different from the first and the second groups of conducting tubes.

6. The electrical switching device as claimed in claim 5, wherein an insulating layer is coated to an outside of the third group of conducting tubes.

7. The electrical switching device as claimed in claim 5, wherein an insulating plate is added to the bottom face of the third conducting plate.

8. The electrical switching device as claimed in claim 6, wherein an insulating plate is added to the bottom face of the third conducting plate.
